(19) United States
(12) Patent Application Publication
(10) Pub. No.: US 2009/0169740 A1
(43) Pub. Date: Jul. 2, 2009

(54) Method for Preventing Crystallization at Nozzle Tips When Loading Different Kinds of SOG Material

(75) Inventors: Kohtaro Teshima, Ohita (JP); Hironobu Aoyagi, Beppu (JP)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 12/344,985

(22) Filed: Dec. 29, 2008

(30) Foreign Application Priority Data
Dec. 28, 2007 (JP) 2007338708

(51) Int. Cl. B05D 1/36; B05C 11/10

(52) U.S. Cl. 427/240; 118/696

(57) ABSTRACT

The objective of the invention is to prevent unwanted dripping of SOG from nozzles and coating of crystallized or solidified particles in an SOG coater that utilizes different kinds of SOG material. The SOG supply method includes a step in which, when executing processing for supplying a first spin-on glass to a lot from a first nozzle, a prescribed amount of second spin-on glass is discharged from a second nozzle at the beginning or the end of the processing of said lot. Furthermore, the SOG supply method includes a step in which the second nozzle is cleaned at the beginning of processing of the substrates contained in a lot.

### FIELD OF THE INVENTION

The present invention pertains to a method for preventing crystallization at nozzle tips when loading different kinds of SOG material (spin-on glass).

### BACKGROUND OF THE INVENTION

Many integrated circuits are formed on a semiconductor substrate, and a multilayer interconnection structure is used for achieving electrical connection/insulation of those integrated circuits. A multilayer interconnection structure includes metal wiring layers, interlayer insulating films, contact holes, via holes, and so forth. Because this kind of multilayer interconnection structure includes a step formed by a contact hole with a high aspect ratio, an SOG film is used in order to flatten said step. The SOG is used in its liquid state and coated over the substrate surface so as to bury the step formed on the substrate surface. Subsequently, the SOG is baked to remove solvent in order to form an SOG film that covers the step. A method for coating the SOG is disclosed in Patent Reference 1, for example.

A variety of SOG materials are available. For example, a phosphorus-doped silicate glass system inorganic SOG, a methylsiloxane system organic SOG, a high methylsiloxane system organic SOG, and liquid polymers may be mentioned. Because these SOG materials have different thermal resistances, contractibilities, and planarities, an SOG material is selected that is suitable for a given step shape and production process of a given multilayer interconnection structure.

Patent Reference 2 discloses a SOG coater that is used to coat SOG on a semiconductor substrate. As shown in FIG. 9, this device is equipped with spin chuck 16 for spinning substrate 14, supply nozzle 18 with an internal conduit, nozzle positioning system 62 for selective positioning of supply nozzle 18 over spin chuck 16 when the SOG is supplied, supply pipe 60 for supplying the SOG, and rinse agent supply pipe 22 that is used to supply a rinse agent in order to remove dried SOG.

(Patent Reference 1) Japanese Kokai Patent Application No. 2000-77396

(Patent Reference 2) Japanese Kokai Patent Application No. Hei 10-209136

During a semiconductor production step, an SOG material suitable for each lot is selected in order to accommodate semiconductor devices to be produced and different production processes. For example, as shown in Patent Reference 2, because the SOG coater has only a single supply nozzle, only 1 kind of SOG can be supplied. As such, when multiple SOG materials are used, SOG devices must be provided in the same quantity as said materials, resulting in high cost. Thus, an SOG coater equipped with 2 supply nozzles capable of supplying different SOG materials according to the production process of each lot has been put to practical applications.

However, an SOG coater equipped with multiple nozzles has the following problems. While an SOG material is being supplied from one nozzle, the supply of SOG material from the other nozzle is stopped. When the supply is stopped, a small portion of the SOG material is sucked in through the nozzle tip, that is, so-called suck-back, whereby dripping of the SOG material from the nozzle is prevented. However, when the nozzle is unused for a long time, the SOG material gradually descends to the nozzle tip, and a drop of the SOG material eventually falls from the nozzle tip and ultimately lies on the substrate.

FIG. 10 illustrates the dripping of the SOG material. Used nozzle A and unused nozzle B are placed above substrate W, SOG material 1 is actually discharged onto the surface of substrate W from used nozzle A, and an unwanted drop of SOG material 2 ends up falling from unused nozzle B after a specific period of time has passed. When a different kind of SOG material ultimately drips onto the substrate, an integrated circuit failure is generated.

Furthermore, the SOG coater is equipped with storage tanks, from which the SOG materials are supplied, and an effluent tank where effluents of the SOG materials are kept. When a storage tank becomes empty, or when an effluent tank begins to overflow, the SOG coater is stopped completely, and sometimes absolutely no SOG material is discharged from either nozzle for an extended period of time. Because the SOG materials contain solvents and thus dry quickly, a long non-discharging condition results in crystallization or solidification of the SOG materials. As such, when the SOG materials are discharged after they have not been used, crystallized SOG materials in the form of particles sometimes fall onto the wafer when the SOG solutions are discharged. Said particles become responsible for integrated circuit failure and degraded production yield.

The present invention aims to solve the aforementioned problems, and its objective is to present an SOG supply method and an SOG coater, whereby dripping of unwanted SOG from nozzles can be prevented, and coating of crystallized or solidified particles can be prevented in an SOG coater that uses different kinds of SOG material.

### SUMMARY OF THE INVENTION

The spin-on glass supply method pertaining to the present invention allows first spin-on glass to be supplied from a first nozzle, second spin-on glass to be supplied from a second nozzle, and the first or the second spin-on glass to be supplied onto a substrate from the first or the second nozzle, wherein multiple lots containing multiple substrates are prepared, and the supplying method includes a step in which a prescribed amount of second spin-on glass is discharged from the second nozzle at the beginning or the end of first lot processing that involves supplying of the first spin-on glass to the first lot from the first nozzle during the execution of the processing.

Preferably, when the processing for supplying the first spin-on glass to the multiple lots from the first nozzle is executed continuously, a prescribed amount of second spin-on glass is discharged from the second nozzle at the beginning or the end of each lot during the aforementioned discharge step. Furthermore, the supplying method is used to discharge a prescribed amount of first spin-on glass from the first nozzle simultaneously with the discharge of the prescribed amount of second spin-on glass from the aforementioned second nozzle. Preferably, when the prescribed amount of second spin-on glass is discharged from the aforementioned second nozzle, the aforementioned second nozzle is at its retreat position away from the substrate.

Furthermore, the spin-on glass supply method pertaining to the present invention allows first spin-on glass to be supplied from a first nozzle, second spin-on glass to be supplied from a second nozzle, and the first or the second spin-on glass to be supplied onto a substrate from the first or the second nozzle, wherein multiple lots containing multiple substrates are prepared, and the supplying method includes a step in which the second nozzle is cleaned at the beginning of processing of a substrate included in the first lot when processing for supplying the first spin-on glass from the first nozzle to the first lot is executed.

Furthermore, the supplying method may include a step in which a prescribed amount of second spin-on glass is discharged from the second nozzle after the second nozzle has been cleaned. Preferably, the aforementioned rinsing step and the aforementioned discharge step are executed at the beginning of the processing of each substrate of the first lot. Preferably, the aforementioned rinsing step includes rinsing of the first nozzle, and the aforementioned discharge step includes discharging of a prescribed amount of first spin-on glass from the first nozzle.

The spin coater pertaining to the present invention is equipped with a first nozzle capable of supplying first spin-on glass, a second nozzle capable of supplying second spin-on glass, a support part for supporting a substrate in a spinnable fashion, a moving means capable of moving the first and the second nozzles respectively from their retreat positions to supply positions, and a control means for executing spin-on glass and rinse agent processing sequences for lots containing multiple substrates, wherein the aforementioned control means discharges a prescribed amount of second spin-on glass from the second nozzle at the beginning or the end of processing of the first lot when executing processing for supplying the first spin-on glass from the first nozzle to the first lot.

Preferably, the aforementioned control means simultaneously discharges a prescribed amount of first spin-on glass from the first nozzle when discharging the prescribed amount of second spin-on glass from the second nozzle.

Furthermore, the spin coater pertaining to the present invention is equipped with a first nozzle capable of supplying first spin-on glass, a second nozzle capable of supplying second spin-on glass, a support part for supporting a substrate in a spinnable fashion, a rinse nozzle for supplying a rinse agent, a movement means that can move the first and second nozzles from retreat positions to supply positions, and a control means for executing spin-on glass and rinse agent processing sequences for lots containing multiple substrates, whereby the aforementioned control means discharges the rinse agent from the discharge nozzle to the second nozzle at the beginning or the end of processing of a substrate contained in the first lot when executing processing for supplying the first spin-on glass from the first nozzle to the first lot.

Preferably, the aforementioned control means discharges a prescribed amount of second spin-on glass from the second nozzle after the second is cleaned. Preferably, the aforementioned control means cleans the area around the first nozzle retreat position using the rinse agent discharged from the rinse nozzle when the first nozzle is away from its retreat position.

### BRIEF DESCRIPTION OF THE DRAWINGS

(FIG. 1)

Schematic cross-section showing an example of a spin coater.

(FIG. 2)

Diagram showing the positional relationship between nozzles at their supply positions and a substrate.

(FIG. 3)

Block diagram showing electrical configuration of the spin coater in the present embodiment.

(FIG. 4)

Flow chart showing a method for supplying the first SOG in the spin coater.

(FIG. 5)

FIG. 5(a) is a diagram for explaining a dripping condition when conventional flow is utilized, and FIG. 5(b) is a diagram for explaining prevention of dripping when the flow of the present embodiment is utilized.

(FIG. 6)

Diagram showing an example of processing of multiple lots using a spin coater.

(FIG. 7)

Flow chart for supplying SOG in a second embodiment of the present invention.

(FIG. 8)

Diagram for explaining an example of cleaning of a rinse pot.

(FIG. 9)

Diagram showing an example of a conventional spin coater.

(FIG. 10)

Diagram for illustrating problems of a conventional spin coater that is capable of supplying different kinds of SOG material.

### REFERENCE NUMERALS AND SYMBOLS AS SHOWN IN THE DRAWINGS

In the figures, 10 represents a spin coater, 20 a first nozzle, 22 an unused nozzle, 24 an unused SOG, 30 a second nozzle, 40 a pot part, 42, 44 openings, 50 a first rinse nozzle, 60 a second rinse nozzle, 70 a support part, 72 a chamber, 74, 76 discharge ports, 80 a chuck, 90, 92 hoses, 100 an effluent tank.

### DESCRIPTION OF THE EMBODIMENTS

According to the present invention, because the spin-on glass is discharged from the unused nozzle at the beginning or the end of the lot, unwanted dripping of the spin-on glass from the unused nozzle can be prevented. Furthermore, according to the present invention, because the unused nozzle is cleaned at the beginning of the processing of the substrates in the lot, crystallization of the spin-on glass on the unused nozzle can be prevented; and even in the event of crystallization, it is appropriately removed, so adhesion to the substrate can be prevented.

Preferred embodiments of the present invention will be explained in detail below with reference to figures. Here, a sheet-fed spin coater will be used as an example.

### Embodiments

FIG. 1 is a schematic diagram showing the outline of a spin coater. As shown in said figure, spin coater 10 is equipped with first nozzle 20 for discharging first spin-on glass, second nozzle 30 for discharging second spin-on glass, pot part 40 for supporting the first and second nozzles, first rinse nozzle 50 capable of rinsing the first nozzle that is attached to pot part 40, second rinse nozzle 60 capable of rinsing the second nozzle that is attached to pot part 40, base part 70 for mounting pot part 40 while forming chamber 72, chuck 80 for supporting a substrate in a spinnable fashion, effluent hoses 90 and 92 that are connected to discharge ports 74 and 76 created on base part 70, and effluent tank 100 for holding effluent from effluent hoses 90 and 92.

First and second nozzles 20 and 30 are connected to respective SOG storage tanks via supply pipes and feed valves, not shown. In addition, first and second nozzles 20 and 30 can be moved from their retreat positions to SOG supply positions, or from supply positions to retreat positions, either simultaneously or individually, by a moving mechanism, not shown. FIG. 1 shows the condition of first and second nozzles 20 and 30 when they are at their retreat positions. At this time, first and second nozzles 20 and 30 are placed inside openings 42 and 44 created on pot part 40, and first and second nozzles 20 and 30 are positioned almost in alignment with discharge ports 74 and 76.

FIG. 2 shows the condition of the nozzles when they are at the supply positions. As shown in said figure, first and second nozzles 20 and 30 are moved together from the retreat positions to the supply positions by moving holder 110. At this time, the nozzle that is actually used to discharge SOG is placed over the center of substrate W. In this case, second nozzle 30 is placed over the center of substrate W. Substrate W is a silicon wafer, for example, and it is fixed on chuck 80. Liquid-state second SOG is supplied onto substrate W from second nozzle 20, and the substrate is spun at a constant speed, whereby the SOG covers a step formed on the surface of substrate W. At this time, unused first nozzle 20 is placed at a position away from the center of substrate W. However, unused first nozzle 20 may be placed at its retreat position inside opening 42 of pot part 40.

In contrast with the above, when first nozzle 20 is used to discharge first SOG, first nozzle 20 is placed above the center of substrate W, and unused second nozzle 30 is placed a position offset from said center, or it may be placed at its retreat position.

First rinse nozzle 50 discharges rinse agent into first nozzle 20 in order to clean the outside of first nozzle 20 when first nozzle 20 is at its retreat position inside opening 42 created on pot part 40. In addition, first rinse nozzle 50 cleans an area that includes opening 42 of pot part 40 using rinse agent when first nozzle 20 is at the supply position.

Similarly, second rinse nozzle 60 discharges rinse agent into the second nozzle 30 when second nozzle 30 is at its retreat position inside opening 44 created on pot part 40 in order to clean the outside of second nozzle 30. In addition, second rinse nozzle 60 rinses an area around opening 44 created on pot part 40 using rinse agent when second nozzle 30 is at the supply position.

FIG. 3 is a block diagram showing the electrical configuration of the spin coater. The spin coater includes chemical supply part 200, rinse supply part 210, nozzle moving part 220, chuck spinning part 230, memory 240, and control part 250.

The amounts of the SOG discharged respectively from first and second nozzles 20 and 30 by chemical supply part 200 and the timing are controlled by control part 250. For example, chemical supply part 200 includes opening/closing valves connected to first and second nozzles 20 and 30, and it opens/closes said valves. The amount of rinse agent discharged respectively from first and second rinse nozzles 50 and 60, that is, the amount of rinse agent discharge, and the timing by rinse supply part 210 are controlled by control part 250. Rinse supply part 210 includes opening/closing valves connected to first and second rinse nozzles 50 and 60, and it opens/closes them.

Nozzle moving part 220 is capable of moving first and second nozzles 20 and 30 to their retreat positions or supply positions under the control of control part 250. Chuck spinning part 230 supports and spins substrate W that is mounted on chuck 80. Memory 240 stores a processing sequence or processing recipes that define the SOG processing steps carried out by the spin coater, and control part 250 controls the respective parts according to said processing sequence.

Next, processing operations carried out by the spin coater will be explained. The spin coater is a sheet-fed type and is capable of coating a different SOG onto each substrate. However, if so executed, the throughput is degraded significantly. Thus, multiple substrates are used to constitute 1 lot, and the same SOG coating is executed for units of one lot. For example, 1 lot can contain roughly 25 substrates.

The SOG supply flowchart pertaining to the first embodiment is shown in FIG. 4. First, multiple lots are prepared (Step S101). Each lot can be managed using a cassette that houses multiple substrates. Once the spin coater is ready for processing after a lot is loaded, control part 250 reads the SOG processing sequence from memory 240 (Step S102) and determines whether first nozzle 20 or second nozzle 30 should be used for the loaded lot based on said processing sequence (Step S103). Control part 250 moves the nozzle to be used to its supply position via nozzle moving part 220 (Step S104).

Once the movement of the nozzle has been completed, control part 250 discharges prescribed amounts of first and second SOGs simultaneously from first and second nozzles 20 and 30 via chemical supply part 200 (Step S105). This discharge is carried out at the beginning of each lot. That is, predispensing to be carried out at the used nozzle is carried out simultaneously at the unused nozzle. Once the predispensing of the first and the second SOGs has been completed, control part 250 discharges the SOGs onto the substrate according to the sequence prescribed in the processing sequence (Step S106).

Once the SOG coating of all the substrates in the lot has been completed (Step S107), processing of the next lot begins (Step S108), the processing is repeated starting from Step S103, and prescribed amounts of first and second SOGs are discharged from first and second nozzles 20 and 30, respectively.

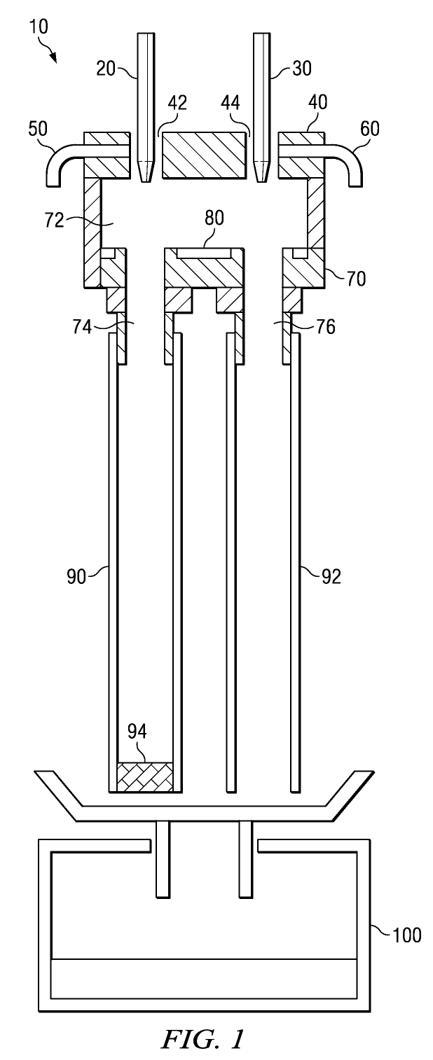

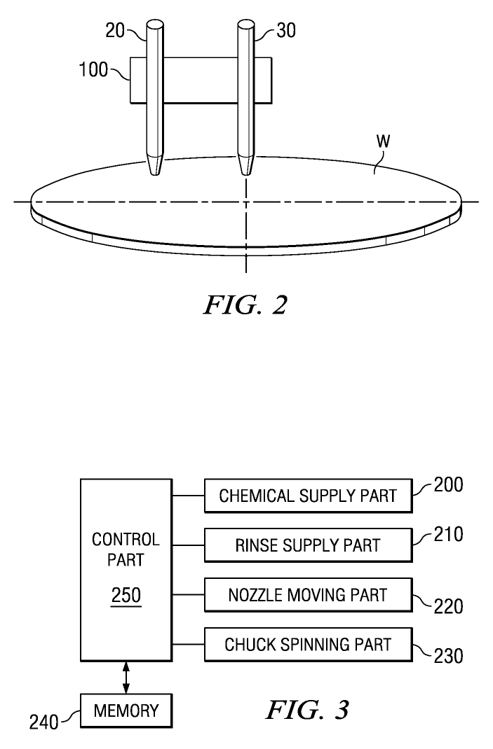

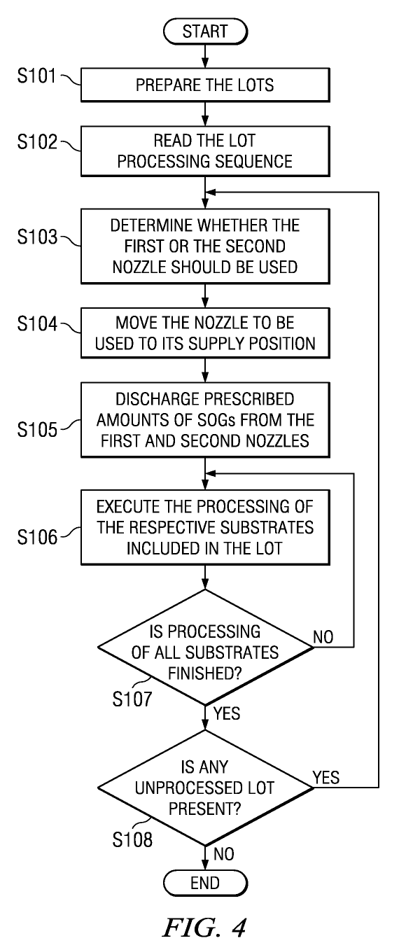

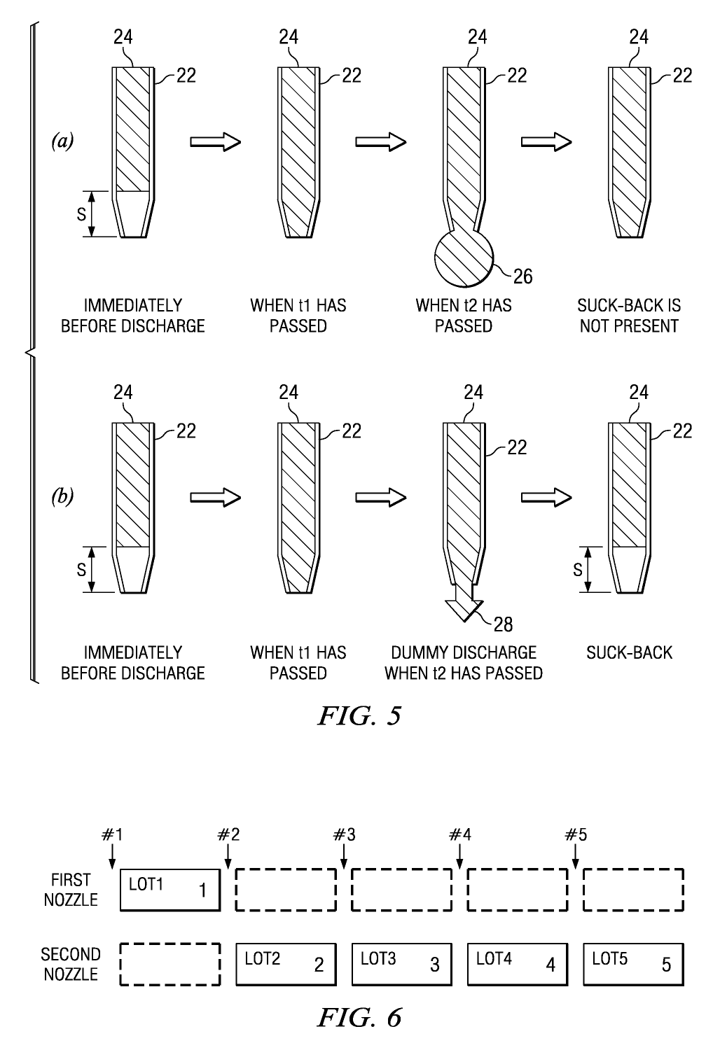

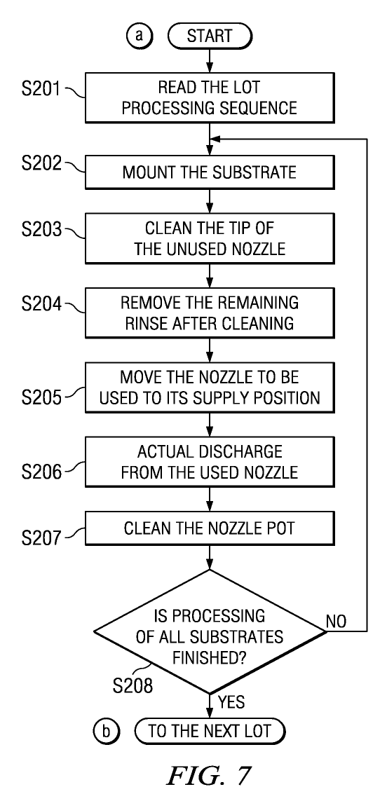

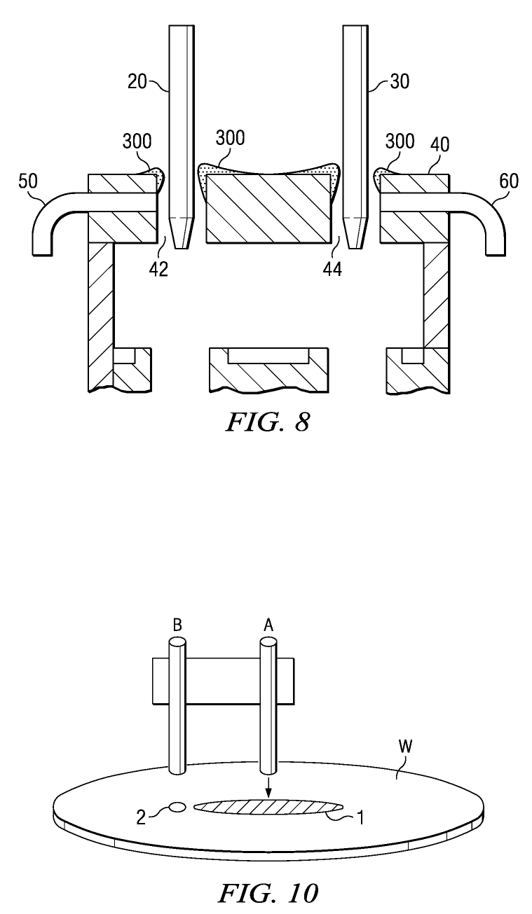

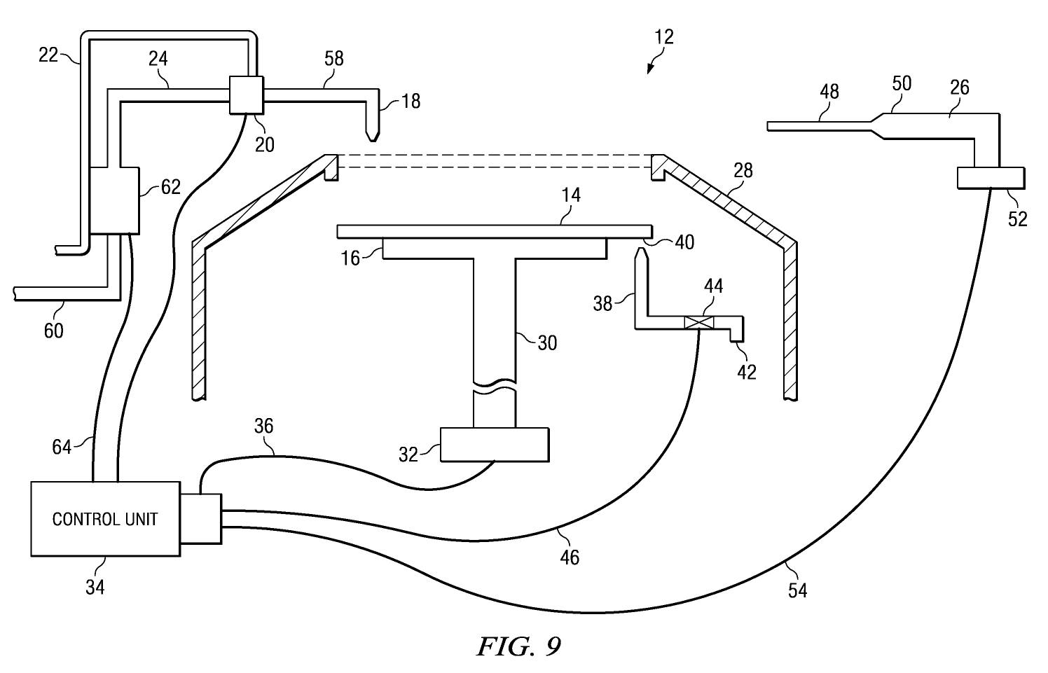

FIG. 5(a) shows an example of conventional SOG supply flow, and FIG. 5(b) shows an example of SOG supply flow in the present embodiment. In FIG. 5(a), a prescribed amount of SOG 24 in unused nozzle 22 is pulled up into the nozzle tip due to a suck-back phenomenon immediately after SOG is discharged. When time t1 has passed from said condition, SOG 24 descends close to the nozzle tip due to gravity; and when additional time t2 has passed, spherical SOG drop 26 is formed at the nozzle tip, and said drop 26 falls. Subsequently, unused nozzle 22 enters a state in which a spherical drop is likely to form without suck-back.

In contrast, in the present embodiment, when time t2 has passed, SOG 28 is dummy-discharged forcibly from unused nozzle 22. As a result, suck-back takes place so as to pull SOG 24 back into unused nozzle 22 through its tip, whereby dripping of the SOG is prevented.

FIG. 6 shows an example of processing of multiple lots by the spin coater. Assume that first nozzle 20 is used for lot 1, and second nozzle 30 is used for lots 2-5. First nozzle 20 essentially is unused during lots 2-5. In the present embodiment, as described above, the second SOG is predispensed from unused second nozzle 30 simultaneously with the predispensing of the first SOG from first nozzle 20 at the beginning #1 of lot 1. Similarly, the first SOG is predispensed from first nozzle 20 simultaneously with the predispensing of the second SOG from the second nozzle at the beginnings #2-5 of lots 2-5.

As described above, when dummy SOG is discharged from the then unused nozzle at the beginning of a lot or between lots, dripping of SOG from the unused nozzle can be prevented. Furthermore, although dummy discharge is carried out after the used nozzle is moved to its retreat position in the aforementioned embodiment, said dummy discharge may be carried out when the first and the second nozzles are at their retreat positions.

Next, a second embodiment of the present invention will be explained. As already explained with reference to the first embodiment, SOG dummy discharge from the unused nozzle is carried out at the beginning of a lot. However, when SOG is discharged frequently, the concentration of the SOG on the effluent retrieving side becomes so high that sometimes the effluent clogs at connection parts 94 (Refer to FIG. 1) between effluent hoses 90 and 92 and effluent tank 100. As a result, the number of maintenances of the spin coater increases, and/or the device has to be stopped. In addition, although crystallization of quick-drying SOG can be restrained somewhat by discharging the SOG from the unused nozzle at the beginning of a lot, in the event of overflow of the effluent tank while working on a lot, depletion of SOG in a storage tank, or the aforementioned clogging of the effluent, the only choice is to stop the spin coater, and the SOG at the unused nozzle is ultimately crystallized. In the second embodiment, a sequence for preventing such crystallization of the SOG at the tip of the unused nozzle and for removing crystallized SOG formed at the nozzle tip will be presented.

FIG. 7 is a diagram showing the flow of the second embodiment. First, control part 250 reads the processing sequence from memory 240 (Step S201), and the first substrate W of the lot is mounted on the chuck (Step S202). Control part 250 discharges a prescribed amount of rinse agent from first and second rinse nozzles 20 and 30 via supply part 210 for a prescribed period of time in order to clean the tips of first and second nozzles 20 and 30 from the outside (Step S203). At this time, first and second rinse nozzles 20 and 30 are place at their retreat positions inside of pot part 40, and the rinse agents from first and second rinse nozzles 50 and 60 are discharged directly to first and second nozzle tips in order to dissolve or remove crystallized SOGs formed on the outside of the nozzle tips. Preferably, a solution that dissolves the SOGs or pure water is used as the rinse agent.

Next, control part 250 discharges prescribed amounts of first and second SOGs from first and second nozzles 20 and 30 via chemical supply part 200. This discharge of the SOGs removes rinse agent adhered to the nozzle tips and removes the crystallized particles remaining inside the first and the second nozzles to the outside (Step S204). As a result, crystallization of the SOGs can be prevented, and crystallized SOGs can be almost completely removed.

Next, control part 250 moves first and second nozzles 20 and 30 from their retreat positions to their supply positions via nozzle moving part 220 (Step S205). Then, SOG is actually discharged from the used nozzle onto the substrate according to the process sequence (Step S206).

After the discharge, control part 250 cleans the nozzle pot before first and second nozzles 20 and 30 return to their retreat positions (Step S207). Rinse supply part 210 discharges a prescribed amount of rinse agent from first and second rinse nozzles 50 and 60 as controlled by control part 250. FIG. 8 is a diagram for explaining the cleaning of the nozzle pot. As shown in said figure, first and second nozzles 20 and 30 are moved from openings 42 and 44 of pot part 40. The SOGs discharged and adhered to the side walls of openings 42 and 44 of nozzle pot 40 and the surface of pot part 40 when first and second nozzles were at the retreat positions are now dried, and crystallized SOG 300 is adhered there. Crystallized SOG 300 is not desirable because it sometimes falls in the forms of particles, resulting in an integrated circuit failure. When the rinse agent is discharged from first and second rinse nozzles 50 and 60, the rinse agent washes off crystallized SOG 300.

Once the cleaning of the nozzle pot is completed, processing of the next substrate in the lot begins. The next substrate is mounted onto the chuck (Step S202), and the same processing as that described above is repeated. When the processing of all of the substrates in the lot has been completed, advancement is made to process the next lot.

As described above, in the present embodiment, because the first and second nozzles are cleaned, and the SOGs are predispensed from the first and the second nozzles at the beginning of the processing of the substrates in a lot, the crystallized SOG formed at the unused nozzle can be removed. Because crystallization is prevented on the substrate unit, and the crystallized SOG is removed, even if the spin coater is stopped for a long time due to an unavoidable circumstance while working on a lot, the coating of the SOG can be resumed from a treated substrate when the device is turned on again. Furthermore, because nozzle pot cleaning is carried out, the occurrence and adhesion of particles can be prevented even more. Furthermore, because the rinse agent is discharged at a constant timing, an increase in the concentration of the SOG solution can be prevented, and clogging of the effluent can thus be prevented.

Although an example was shown in the aforementioned embodiment in which the SOG was predispensed after the nozzle tip was cleaned, this order may be reversed. That is, crystallized SOG on the outside of the nozzle may be removed using the rinse nozzle after the crystallized SOG is removed by predispensing the SOG. In this case, the relationship between the discharged rinse agent and the SOG is desirably SOG>rinse agent. This is because a void is formed at the nozzle tip during the suck-back, so the rinse agent and the SOG are unlikely to mix when the nozzle rinse agent is discharged.

Furthermore, it is also feasible to combine the aforementioned first embodiment and the second embodiment in the SOG supply method of the present invention. That is, the step in which the prescribed amount of SOG is discharged from the unused nozzle at the beginning or the end of the lot and the step in which the crystallized SOG at the unused nozzle is removed (cleaning of the nozzle and discharging of the SOG) at the beginning of each substrate in a lot may both be included.

Furthermore, although an example was shown in the aforementioned embodiment in which the nozzle cleaning was carried out at the beginning of processing of all the substrates included in a lot, it does not have to be done that way. That is, the nozzle may be cleaned a prescribed number of times within 1 lot, for example, N times (N is smaller than the number of substrates) per 1 lot. Alternatively, the nozzle may be cleaned during the processing of even-numbered or odd-numbered substrates within 1 lot.

Preferred embodiments of the present invention have been described in detail, but the present invention is not restricted to the specific embodiments, and the present invention can be modified/changed in a variety of ways within the scope of the present invention described in the claims.

1. A spin-on glass supplying method that allows first spin-on glass to be supplied from a first nozzle, second spin-on glass to be supplied from a second nozzle, and the first or the second spin-on glass to be supplied onto a substrate from the first or the second nozzle, wherein
multiple lots containing multiple substrates are prepared, and
the supplying method comprises
a step in which a prescribed amount of second spin-on glass is discharged from the second nozzle at the beginning or the end of first lot processing that involves supplying of the first spin-on glass to the first lot from the first nozzle during the execution of the processing.

2. The supplying method described under claim 1, wherein, when the processing for supplying the first spin-on glass to the multiple lots from the first nozzle is executed continuously, a prescribed amount of second spin-on glass is discharged from the second nozzle at the beginning or the end of each lot during the aforementioned discharge step.

3. The supplying method described under claim 1, wherein the supplying method is used to discharge a prescribed amount of first spin-on glass from the first nozzle simultaneously with the discharge of the prescribed amount of second spin-on glass from the aforementioned second nozzle.

4. The supplying method described under claim 1, wherein, when the prescribed amount of second spin-on glass is discharged from the aforementioned second nozzle, the aforementioned second nozzle is at its retreat position away from the substrate.

5. A supplying method that is a spin-on glass supplying method that allows first spin-on glass to be supplied from a first nozzle, second spin-on glass to be supplied from a second nozzle, and the first or the second spin-on glass to be supplied onto a substrate from the first or the second nozzle, wherein
multiple lots containing multiple substrates are prepared, and
the supplying method comprises
a step in which the second nozzle is cleaned at the beginning of processing of a substrate included in the first lot when processing for supplying the first spin-on glass from the first nozzle to the first lot is executed.

6. The supplying method described under claim 5, wherein the supplying method further comprises a step in which a prescribed amount of second spin-on glass is discharged from the second nozzle after the second nozzle has been cleaned.

7. The supplying method described under claim 5, wherein the aforementioned rinsing step and the aforementioned discharge step are executed at the beginning of the processing of each substrate of the first lot.

8. The supplying method described under claims 5, wherein the aforementioned rinsing step comprises rinsing of the first nozzle, and the aforementioned discharge step includes discharge of a prescribed amount of first spin-on glass from the first nozzle.

9. A sheet-fed spin coater comprising:
a first nozzle capable of supplying first spin-on glass,
a second nozzle capable of supplying second spin-on glass,
a support part for supporting a substrate in a spinnable fashion,
a moving means capable of moving the first and the second nozzles respectively from their retreat positions to supply positions, and
a control means for executing spin-on glass and rinse agent processing sequences for lots containing multiple substrates, wherein
the aforementioned control means discharges a prescribed amount of second spin-on glass from the second nozzle at the beginning or the end of processing of the first lot when executing processing for supplying the first spin-on glass from the first nozzle to the first lot.

10. The sheet-fed spin coater described under claim 9, wherein the aforementioned control means simultaneously discharges a prescribed amount of first spin-on glass from the first nozzle when discharging the prescribed amount of second spin-on glass from the second nozzle.

11. A sheet-fed spin coater comprising:
a first nozzle capable of supplying first spin-on glass,
a second nozzle capable of supplying second spin-on glass,
a support part for supporting a substrate in a spinnable fashion,
a rinse nozzle for supplying a rinse agent,
a movement means that can move the first and second nozzles from retreat positions to supply positions, and
a control means for executing spin-on glass and rinse agent processing sequences for lots containing multiple substrates, whereby the aforementioned control means discharges the rinse agent from the discharge nozzle to the second nozzle at the beginning or the end of processing of a substrate contained in the first lot when executing processing for supplying the first spin-on glass from the first nozzle to the first lot.

12. The sheet-fed spin coater described under claim 11, wherein the aforementioned control means discharges a prescribed amount of second spin-on glass from the second nozzle after the second nozzle has been cleaned.

13. The sheet-fed spin coater described under claim 11, wherein the aforementioned control means cleans the area around the first nozzle retreat position using the rinse agent discharged from the rinse nozzle when the first nozzle is away from its retreat position.
